(19) United States
(12) Patent Application Publication
(10) Pub. No.: US 2023/0187601 A1
(43) Pub. Date: Jun. 15, 2023

(54) METHOD FOR MANUFACTURING ELECTRODE PLATE AND METHOD FOR MANUFACTURING BATTERY

(71) Applicants: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(72) Inventors: Naoki WAKAMATSU, Toyohashi-shi (JP); Hiroki NAKAFUJI, Toyohashi-shi (JP); Yoshinori KUDO, Toyohashi-shi (JP)

(73) Assignees: PRIMEARTH EV ENERGY CO., LTD., Kosai-shi, Shizuoka (JP); TOYOTA JIDOSHA KABUSHIKI KAISHA, Toyota-shi, Aichi-ken (JP); PRIME PLANET ENERGY & SOLUTIONS, INC., Tokyo (JP)

(21) Appl. No.: 18/078,025

(22) Filed: Dec. 8, 2022

(30) Foreign Application Priority Data
Dec. 13, 2021 (JP) 2021-201607

(51) Int. Cl. H01M 4/04

(52) U.S. Cl. CPC H01M 4/043; H01M 2004/021

(57) ABSTRACT

A method for manufacturing an electrode plate including a current collector and an active material layer includes preparing, forming, and pressing. In the preparing, a mixture is prepared by kneading an active material. In the forming, the active material layer is formed on the current collector by applying the mixture to the current collector. In the pressing, the active material layer is pressed so that active material layer has a predetermined thickness. The mixture applied to the current collector has a weight per unit area based on a specific surface area of the active material used in the mixture and a tapped density of the active material used in the mixture.

### BACKGROUND

### 1. Field

The following description relates to a method for manufacturing an electrode plate and a method for manufacturing a battery.

### 2. Description of Related Art

Japanese Laid-Open Patent Publication No. 10-116604 describes a battery including an electrode plate. The electrode plate includes a current collector and an active material layer on the current collector. The active material layer is formed by, for example, applying a mixture including an active material to the current collector. The active material layer is formed on the current collector and then pressed. This manufactures the electrode plate.

Japanese Laid-Open Patent Publication No. 10-116604 describes that the specific surface area of the active material included in the active material layer affects the performance of the electrode plate and that the specific surface area of the active material is increased by the pressing of the active material layer.

The active material used in the mixture has a physical property that is varied in accordance with certain conditions. For example, active materials of the same type may differ in specific surface area, tapped density, and the like. Such difference in physical property of the active material included in the mixture may vary the amount of increase in the specific surface area of the active material even when the active material layer is pressed under the same condition. Thus, differences in the physical properties between the mixtures may vary the performance of the electrode plates.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method for manufacturing an electrode plate including a current collector and an active material layer includes preparing, forming, and pressing. In the preparing, a mixture is prepared by kneading an active material. In the forming, the active material layer is formed on the current collector by applying the mixture to the current collector. In the pressing, the active material layer is pressed so that active material layer has a predetermined thickness. The mixture applied to the current collector has a weight per unit area based on a specific surface area of the active material used in the mixture and a tapped density of the active material used in the mixture.

In the method, when the electrode plate is manufactured with the mixture using the active material of which the specific surface area is a first area, the weight per unit area of the mixture may be less than that when the electrode plate is manufactured with a mixture using the active material where the specific surface area is a second area that is smaller than the first area.

In the method, when the electrode plate is manufactured with the mixture using the active material of which the specific surface area is the first area and the tapped density is a first density, the weight per unit area of the mixture may be less than that when the electrode plate is manufactured with a mixture using the active material where the specific surface area is the first area and the tapped density is a second density that is greater than the first density.

In the method, when the electrode plate is manufactured with the mixture using the active material of which the specific surface area is the second area and the tapped density is a first density, the weight per unit area of the mixture may be less than that when the electrode plate is manufactured with a mixture using the active material where the specific surface area is the second area and the tapped density is a second density that is greater than the first density.

In another general aspect, a method for manufacturing a battery including an electrode plate that has a current collector and an active material layer includes preparing, forming, and pressing. In the preparing, a mixture is prepared by kneading an active material. In the forming, the active material layer is formed on the current collector by applying the mixture to the current collector. In the pressing, the active material layer is pressed so that active material layer has a predetermined thickness. The mixture applied to the current collector has a weight per unit area based on a specific surface area of the active material used in the mixture and a tapped density of the active material used in the mixture.

Other features and aspects will be apparent from the following detailed description, the drawings, and the claims.

### BRIEF DESCRIPTION OF THE DRAWINGS

FIG. 1 is a perspective view of an assembled battery.

FIG. 2 is a diagram of an electrode body partially in an unrolled state.

FIG. 3 is a flowchart illustrating a method for manufacturing an electrode plate.

FIG. 4 is a table indicating physical properties of active materials.

FIG. 5 is a graph illustrating thicknesses of active material layers when mixtures have the same weight per unit area.

FIG. 6 is a graph illustrating the relationship of a change in the thickness of an active material layer resulting from pressing of the active material layer and an amount of increase in a specific surface area of an active material resulting from the pressing.

FIG. 7 is a graph illustrating changes in the specific surface area of the active materials when the mixtures have the same weight per unit area.

FIG. 8 is a graph illustrating the thicknesses of the active material layers when the mixtures have different weights per unit area based on the physical properties of the active materials.

FIG. 9 is a graph illustrating changes in the specific surface area of the active materials when the mixtures have different weights per unit area based on the physical properties of the active materials.

FIG. 10 is a table indicating the change in the thickness of the active material layers resulting from the pressing and the amount of increase in the specific surface area of the active materials resulting from the pressing for each mixture.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

A method for manufacturing an electrode plate and a method for manufacturing a battery will now be described with reference to the drawings. First, a battery including an electrode plate will be described. The battery is, for example, a lithium-ion battery. The battery may be, for example, an alkaline secondary cell or other batteries.

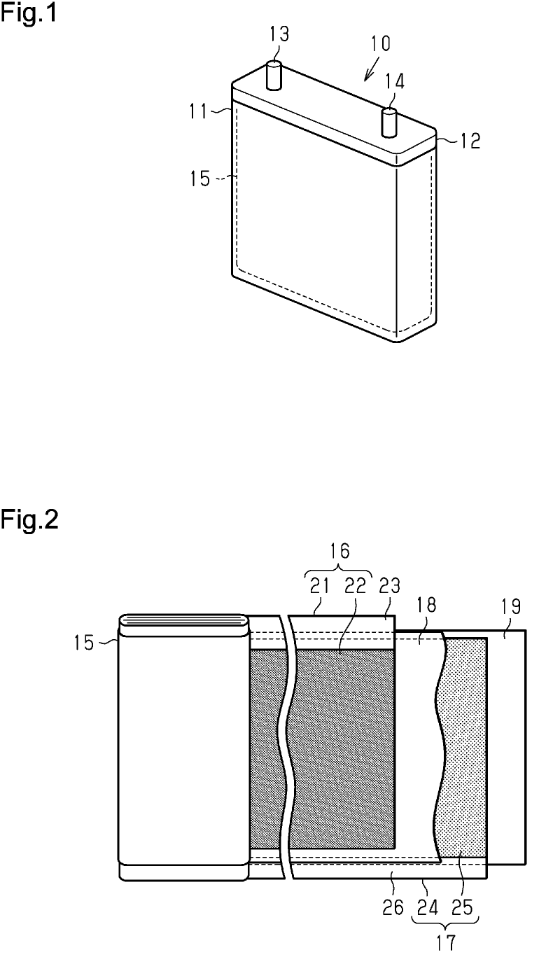

As shown in FIG. 1, a battery 10 includes a case 11 and a lid 12 that closes an opening of the case 11. The battery 10 includes a positive electrode terminal 13 and a negative electrode terminal 14. The positive electrode terminal 13 and the negative electrode terminal 14 extend from the lid 12.

The battery 10 includes an electrode body 15. The electrode body 15 is arranged inside the case 11. The electrode body 15 is accommodated in the case 11 together with an electrolyte. The electrode body 15 is connected to the positive electrode terminal 13 and the negative electrode terminal 14. The positive electrode terminal 13 and the negative electrode terminal 14 do not have to be shaped as shown in FIG. 1 and may be shaped to have other forms.

As shown in FIG. 2, the electrode body 15 includes a positive plate 16, a negative plate 17, a separator 18, and a separator 19. The electrode body 15 is a rolled stack of the positive plate 16, the negative plate 17, the separator 18, and the separator 19. The positive plate 16, the separator 18, the negative plate 17, and the separator 19 are stacked in this order and rolled together. The separator 18 and the separator 19 are, for example, a nonwoven fabric formed from resin.

The positive plate 16 includes a positive electrode current collector 21 and a positive electrode active material layer 22. The positive electrode current collector 21 is, for example, a metal foil. The positive electrode current collector 21 is formed from, for example, a material including aluminum.

The positive electrode current collector 21 includes a connection portion 23. The connection portion 23 is a portion electrically connected to the positive electrode terminal 13. The connection portion 23 is located at an end of the positive electrode current collector 21. The connection portion 23 is a portion of the positive electrode current collector 21 where the positive electrode active material layer 22 is not formed.

The positive electrode active material layer 22 is arranged on the positive electrode current collector 21. The positive electrode active material layer 22 is located on one of or both surfaces of the positive electrode current collector 21. The positive electrode active material layer 22 includes a positive electrode active material. The positive electrode active material layer 22 is formed by applying a mixture including the positive electrode active material to the positive electrode current collector 21.

The positive electrode active material is, for example, a material capable of absorbing and releasing lithium. The positive electrode active material is, for example, a lithium-containing composite oxide. The lithium-containing composite oxide is an oxide including lithium and another metal element other than lithium.

The negative plate 17 includes a negative electrode current collector 24 and a negative electrode active material layer 25. The negative electrode current collector 24 is, for example, a metal foil. The negative electrode current collector 24 is formed from, for example, a material including copper.

The negative electrode current collector 24 includes a connection portion 26. The connection portion 26 is a portion electrically connected to the negative electrode terminal 14. The connection portion 26 is located at an end of the negative electrode current collector 24. The connection portion 26 is a portion of the negative electrode current collector 24 where the negative electrode active material layer 25 is not formed.

The negative electrode active material layer 25 is arranged on the negative electrode current collector 24. The negative electrode active material layer 25 is located on one of or both surfaces of the negative electrode current collector 24. The negative electrode active material layer 25 includes a negative electrode active material. The negative electrode active material layer 25 is formed by applying a mixture including the negative electrode active material to the negative electrode current collector 24.

The negative electrode active material is, for example, a material capable of absorbing and releasing lithium. The negative electrode active material is, for example, a carbon material. The negative electrode active material is, for example, graphite such as natural graphite or artificial graphite.

The method for manufacturing an electrode plate will now be described. The method is for manufacturing the positive plate 16 and the negative plate 17. The positive plate 16 and the negative plate 17 use different materials but are manufactured in the same manner. Accordingly, hereinafter, the positive plate 16 and the negative plate 17 may be referred to as electrode plates, the positive electrode current collector 21 and the negative electrode current collector 24 may be referred to as current collectors, the positive electrode active material layer 22 and the negative electrode active material layer 25 may be referred to as active material layers, and the positive electrode active material and the negative electrode active material may be referred to as active materials.

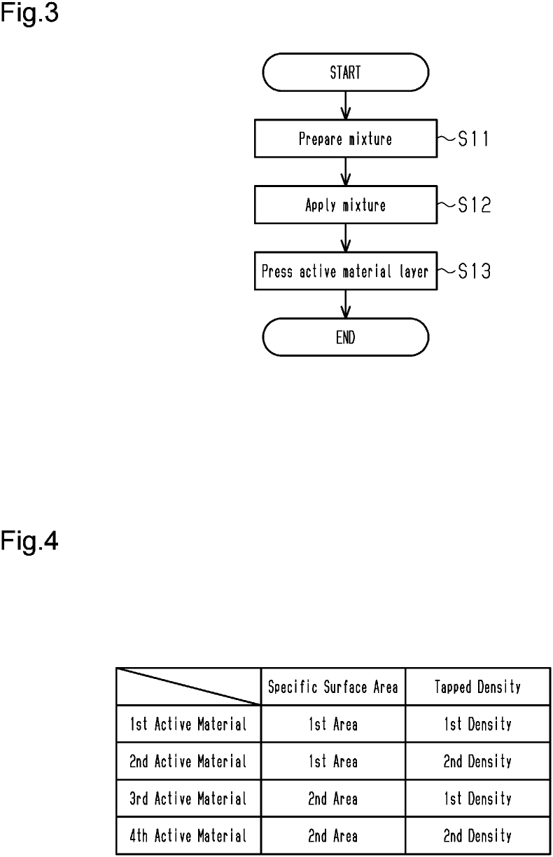

As shown in FIG. 3, in step S11, an active material is kneaded to prepare a mixture. For example, a kneader is used to knead the active material so as to prepare the mixture. The mixture may be prepared by kneading other materials, such as a binder, a solvent, a conductive agent, and a dispersant, in addition to the active material. In the present example, the mixture is prepared by kneading the active material, a binder, and a solvent. The binder is a material for increasing the force binding the particles of the active material. The conductive agent is a material for imparting conductivity to the mixture. The dispersant is a material for evenly dispersing the active material. If the mixture is prepared by kneading only the active material, it is preferred that the active material be adhesive. A paste of the mixture is prepared by the process of step S11.

Another material such as a viscosity increasing agent and the like may be kneaded in addition to the substances described above.

In step S12, the mixture is applied to a current collector. For example, a coating device, such as a slit coater or a die coater, is used to apply the mixture to the current collector. The active material layer is formed on the current collector by the process of step S12.

The mixture applied to the current collector has a predetermined weight per unit area. The term “weight per unit area” refers to the mass per unit area. The weight per unit area is changed by controlling the coating device. The mixture applied to the current collector forms an active material layer having a first thickness. The first thickness is determined by the weight per unit area of the mixture.

In step S13, the active material layer is pressed. For example, a pressing machine is used to press the active material layer. In this case, the pressing machine presses the current collector and the active material layer. An electrode plate is manufactured by the processing of step S13. The electrode body 15 is produced with the electrode plates to manufacture the battery 10.

The active material layer is pressed to a predetermined second thickness. The second thickness is changed by controlling the pressing machine. When the active material layer is pressed, the active material layer is compressed from the first thickness to the second thickness. In other words, the first thickness is the thickness of the active material layer before the pressing. The second thickness is the thickness of the active material layer after the pressing.

The active material layer may be dried when manufacturing the electrode plate. The active material layer may be dried before or after the pressing step. For example, the active material layer may be dried by blasting hot air or dried in a vacuum environment.

The performance of the battery 10 is affected by the performance of the electrode plate. The performance of the electrode plate is determined by a reactive area of the electrode plate. Thus, when manufacturing electrode plates, it is important that variations in the reactive area be reduced between electrode plates. The reactive area of the electrode plate is determined by the specific surface area of the active material included in the active material layer.

The active material used for the mixture may have physical properties that vary. For example, the physical properties of the active material may vary between lots provided by a supplier. Specifically, the active material may vary in specific surface area and tapped density. This may vary the performance of the electrode plate.

As shown in FIG. 4, a first active material, a second active material, a third active material, and a fourth active material have different physical properties. The first to fourth active materials are active materials of the same type. In the first active material, the specific surface area is a first area and the tapped density is a first density. In the second active material, the specific surface area is the first area and the tapped density is a second density. In the third active material, the specific surface area is a second area and the tapped density is the first density. In the fourth active material, the specific surface area is the second area and the tapped density is the second density. The first area is greater than the second area. The first density is less than the second density.

Electrode plates are respectively prepared with a mixture using the first active material, a mixture using the second active material, a mixture using the third active material, and a mixture using the fourth active material. The mixtures using the first to fourth active materials differ only in the physical property of the active material. Otherwise, the other used materials, weight ratio of the materials, and the mass of the active material are the same.

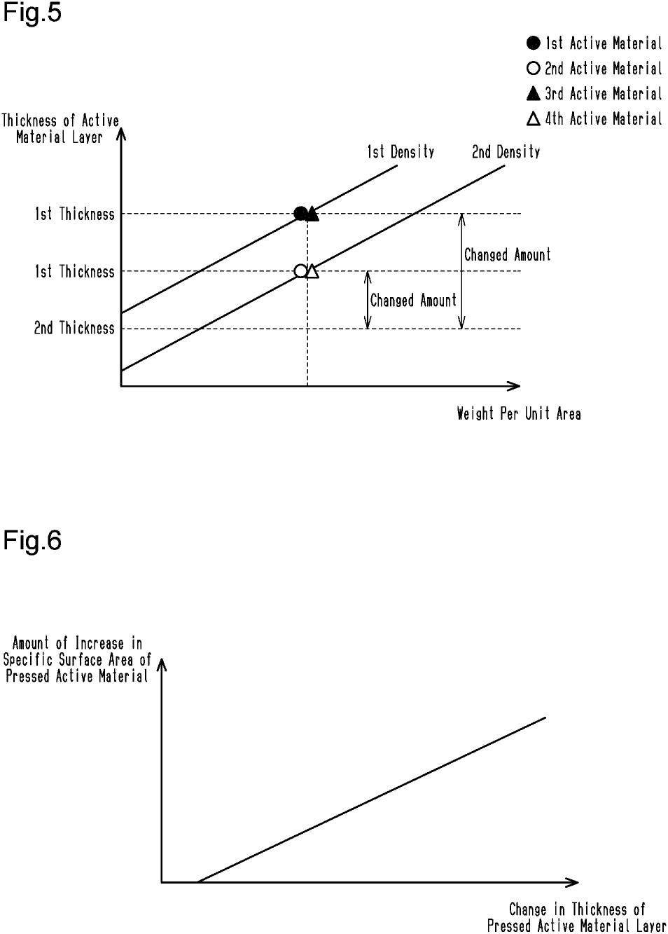

As shown in FIG. 5, when the mixtures using the first to fourth active materials are each applied to current collectors at the same weight per unit area, the active material layers differ in the first thickness. Specifically, the first thickness of the active material layer including the first active material and the first thickness of the active material layer including the third active material are greater than the first thickness of the active material layer including the second active material and the first thickness of the active material layer including the fourth active material. This is caused by the difference in the tapped density of the active materials.

As the tapped density of the active material used in the mixture decreases, the density of the mixture decreases. Thus, when the mixtures have the same weight per unit area, a lower tapped density of the active material used in the mixture results in a greater first thickness of the active material layer. In this manner, when the mixtures have the same weight per unit area, the active material layer including an active material of which the tapped density is relatively low has a greater first thickness than the active material layer including an active material of which the tapped density is relatively high.

The active material layers respectively including the first to fourth active materials are pressed so that the active material layers are compressed to the second thickness. The second thickness is set to a constant value regardless of the physical property of the active material used in the mixture because it is preferred that the thickness of the electrode plate be the same when manufacturing the battery 10. If the thickness of the electrode plate were to differ in accordance with the mixture used, the difference would affect the thickness of the electrode body 15. This complicates the design of the battery 10.

When the active material layers respectively including the first to fourth active materials are pressed, the pressing changes the thickness of the active material layers by different amounts. Specifically, the change in the thickness of the active material layer including the first active material and the change in the thickness of the active material layer including the third active material are greater than the change in the thickness of the active material layer including the second active material and the change in the thickness of the active material layer including the fourth active material.

A greater first thickness results in a greater change in the thickness of the pressed active material layer. Therefore, when the mixtures have the same weight per unit area, a lower tapped density of the active material used in the mixture results in a greater change in the thickness of the pressed active material layer.

The specific surface area of the active material included in the active material layer is increased by the pressing of the active material layer. It can be determined that this is because the active material included in the active material layer is deformed by the pressing.

As shown in FIG. 6, the amount of increase in the specific surface area of the active material changes as the thickness of the pressed active material layer changes. Specifically, as the change in the thickness of the pressed active material layer increases, the specific surface area of the active material is increased by a larger amount. Therefore, when the mixtures have the same weight per unit area, a lower tapped density of the active material used in the mixture results in a greater amount of increase in the specific surface area of the pressed active material layer.

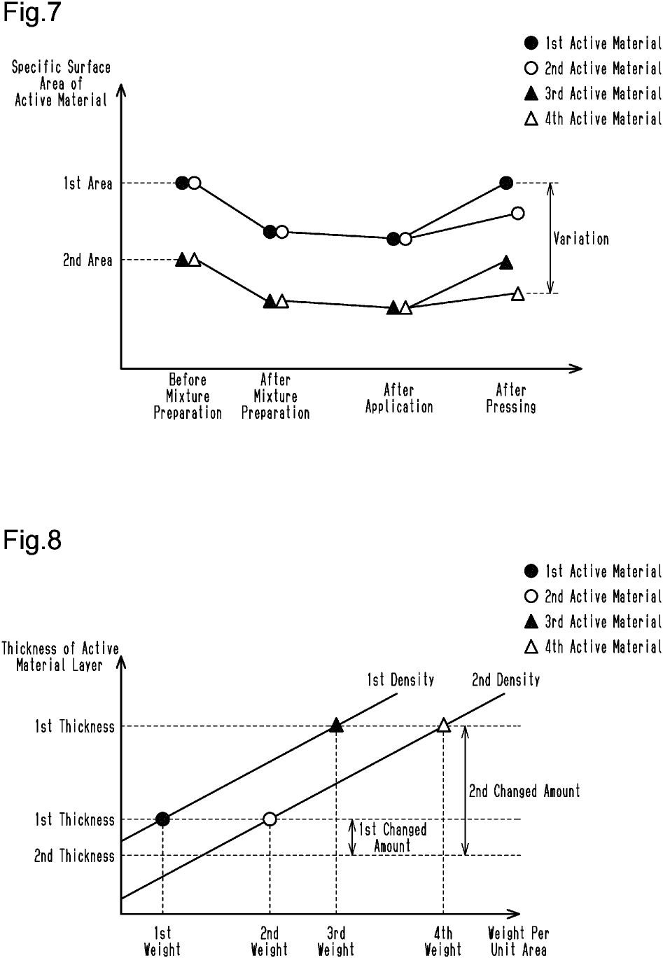

As shown in FIG. 7, changes occur in the specific surface area of the active material not only during the pressing step but throughout the manufacture of the electrode plate. The specific surface area can be measured through, for example, the Brunauer, Emmett and Teller (BET) method.

The specific surface area of the active material before the mixture is prepared corresponds to, for example, the specific surface area of the active material before the kneader is loaded with the active material. The specific surface area of the first active material before the mixture is prepared is the first area. The specific surface area of the second active material before the mixture is prepared is the first area. The specific surface area of the third active material before the mixture is prepared is the second area. The specific surface area of the fourth active material before the mixture is prepared is the second area.

The specific surface area of the active material after the mixture is prepared corresponds to the specific surface area of the active material included in the mixture. As shown in FIG. 7, the specific surface area of the active material after the mixture is prepared is less than that before the mixture is prepared. This is because kneading changes the surface shape of the active material. Further, the binder covering the active material also decreases the specific surface area.

The specific surface area of the active material subsequent to the applying step corresponds to the specific surface area of the active material included in the active material layer prior to the pressing step. The specific surface area of the active material subsequent to the applying step is substantially not changed or is slightly decreased from that subsequent to the preparation of the mixture.

The specific surface area of the pressed active material corresponds to the specific surface area of the active material included in the pressed active material layer. The specific surface area of the active material subsequent to the pressing step is increased from that subsequent to the applying step. In the example shown in FIG. 7, after the pressing step, the value of the specific surface area is, from greatest to smallest, the first active material, the second active material, the third active material, and the fourth active material, in that order.

The difference in the specific surface area between the active materials before the mixture is prepared is likely to result in a difference in the specific surface area between the pressed active materials. Also, the difference in the tapped density between the active materials leads to the difference in the increased amount of the specific surface area of the pressed active materials. Thus, when the physical property of the active material used in the mixture differs between the mixtures, the specific surface area of the active material is likely to vary between the pressed active materials. The difference in the specific surface area between the pressed active materials leads to a difference in the reactive area between the electrode plates. Therefore, the performance of the electrode plate is likely to vary in accordance with the difference in the physical properties of the active materials used in the mixtures.

As shown in FIG. 8, in the present example, the weight per unit area of the mixture is set to differ based on the physical property of the active material used in the mixture. For example, a user operates the coating device to change the weight per unit area of the mixture based on the physical property of the active material used in the mixture. The coating device may automatically determine the physical property of the active material used in the mixture and change the weight per unit area of the mixture.

The mixture using the first active material has a first weight. The mixture using the second active material has a second weight. The mixture using the third active material has a third weight. The mixture using the fourth active material has a fourth weight. The weight per unit area of the mixtures is, from smallest to greatest, the first weight, the second weight, the third weight, and the fourth weight, in that order. That is, the first weight is less than the second weight, the second weight is less than the third weight, and the third weight is less than the fourth weight.

In the present example, the weight per unit area of the mixture is set to differ based on the specific surface area of the active material used in the mixture. When the electrode plate is manufactured with the mixture using an active material of which the specific surface area is relatively large, the mixture has a smaller weight per unit area than when the electrode plate is manufactured with the mixture using an active material of which the specific surface area is relatively small. For example, when the electrode plate is manufactured with the mixture using an active material of which the specific surface area is the first area, the mixture has a smaller weight per unit area than when the electrode plate is manufactured with the mixture using an active material of which the specific surface area is the second area. Specifically, when the electrode plate is manufactured with the mixture using the first or second active material, the mixture has a smaller weight per unit area than when the electrode plate is manufactured with the mixture using the third or the fourth active material. In this manner, in the present example, the weight per unit area of the mixture is decreased when the electrode plate is manufactured with the mixture using an active material of which the specific surface area is relatively large, and the weight per unit area of the mixture is increased when the electrode plate is manufactured with the mixture using an active material of which the specific surface area is relatively small.

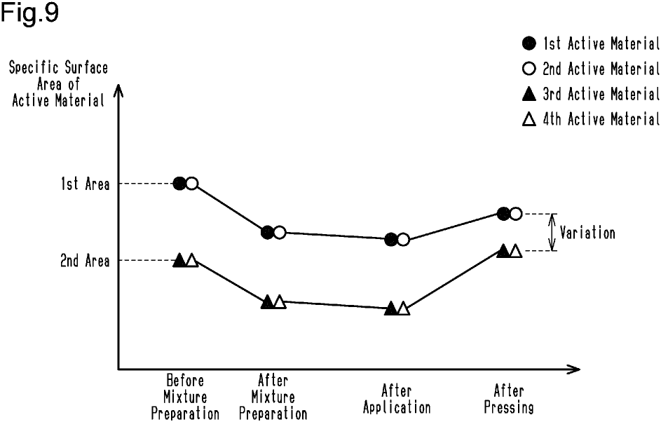

As shown in FIG. 9, when the weight per unit area of a mixture is changed, the amount by which the specific surface area of the pressed active material increases changes. When the electrode plate is manufactured with the mixture using an active material of which the specific surface area is the first area, the weight per unit area of the mixture is decreased from that when the electrode plate is manufactured with the mixture using an active material of which the specific surface area is the second area so that the specific surface area of the pressed active material is increased by a smaller amount. Specifically, when the electrode plate is manufactured with the mixture using the first or second active material, the weight per unit area of the mixture is decreased from that when the electrode plate is manufactured with the mixture using the third or fourth active material so that the specific surface area of the pressed active material is increased by a smaller amount.

When manufacturing the electrode plate, the weight per unit area of the mixture is changed so that the specific surface area of the pressed active material that initially had a relatively large specific surface area is increased by a smaller amount and so that the specific surface area of the pressed active material that initially had a relatively small specific surface area is increased by a greater amount. In other words, when the electrode plate is manufactured with the mixture using an active material of which the specific surface area is relatively large, the weight per unit area of the mixture is decreased so that the specific surface area is increased by a smaller amount. When the electrode plate is manufactured with the mixture using the active material of which the specific surface area is relatively small, the weight per unit area of the mixture is increased so that the specific surface area is increased by a greater amount. This increases the specific surface area of the pressed active material so that the difference in the specific surface area from the original state is reduced. Consequently, this reduces differences in the reactive area between the electrode plates.

As shown in FIG. 8, in the present example, the weight per unit area of the mixture is set to differ based on the tapped density of the active material used in the mixture, in addition to the specific surface area of the active material used in the mixture. Even when the active materials used in the mixtures have the same specific surface area, if the tapped density of the active materials differ between the mixtures, the mixtures have different densities. Accordingly, even when the active materials used in the mixtures have the same specific surface area, if the mixtures have the same weight per unit area, the first thickness will vary between the active material layers. Thus, even when the active materials used in the mixtures have the same the specific surface area, if the active materials have different tapped densities, the specific surface area of the pressed active materials is likely to vary. Therefore, even when the active materials have the same specific surface area before the mixtures are prepared, if the mixtures have different the tapped densities, the specific surface area of the pressed active materials is likely to differ one from another.

In the present example, when the electrode plate is manufactured with the mixture using an active material of which the specific surface area is the first area and the tapped density is the first density, the mixture has a smaller weight per unit area as compared with when the electrode plate is manufactured with the mixture using an active material of which the specific surface area is the first area and the tapped density is the second density. Specifically, when the electrode plate is manufactured with the mixture using the first active material, the mixture has a smaller weight per unit area than when the electrode plate is manufactured with the mixture using the second active material. This reduces the difference in the amount of increase in the specific surface area between the pressed active materials.

In the present example, when the electrode plate is manufactured with the mixture using an active material of which the specific surface area is the second area and the tapped density is the first density, the mixture has a smaller weight per unit area as compared with when the electrode plate is manufactured with the mixture using an active material of which the specific surface area is the second area and the tapped density is the second density. Specifically, when the electrode plate is manufactured with the mixture using the third active material, the mixture has a smaller weight per unit area than when the electrode plate is manufactured with the mixture using the fourth active material. This reduces the difference in the amount of increase in the specific surface area between the pressed active materials.

When manufacturing the electrode plate, the weight per unit area of the mixture is changed so that the specific surface area of the pressed active material, of which the tapped density is relatively small, is increased by a smaller amount and so that the specific surface area of the pressed active material, of which the tapped density is relatively large, is increased by a greater amount. This reduces the difference in the increased amount in the specific surface area of the pressed active material between when the electrode plate is manufactured with the mixture using an active material of which the tapped density is the first density and when the electrode plate is manufactured with the mixture using the active material of which the tapped density is the second density. Consequently, this reduces differences in the reactive area between the electrode plates.

In the present example, the weight per unit area of the mixture is adjusted so that the first thickness when the electrode plate is manufactured with the mixture using the first active material coincides with that when the electrode plate is manufactured with the mixture using the second active material. Thus, the change in the thickness of the pressed active material layer when the electrode plate is manufactured with the mixture using the first active material coincides with that when the electrode plate is manufactured with the mixture using the second active material. Therefore, the amount of increase in the specific surface area of the pressed active material when the electrode plate is manufactured with the mixture using the first active material coincides with that when the electrode plate is manufactured with the mixture using the second active material. Consequently, this reduces differences in the reactive area between the electrode plates.

In the present example, the weight per unit area of the mixture is adjusted so that the first thickness when the electrode plate is manufactured with the mixture using the third active material coincides with that when the electrode plate is manufactured with the mixture using the fourth active material. Thus, the change in the thickness of the pressed active material layer when the electrode plate is manufactured with the mixture using the third active material coincides with that when the electrode plate is manufactured with the mixture using the fourth active material. Therefore, the amount of increase in the specific surface area of the pressed active material when the electrode plate is manufactured with the mixture using the third active material coincides with that when the electrode plate is manufactured with the mixture using the fourth active material. Consequently, this reduces differences in the reactive area between the electrode plates.

When the electrode plate is manufactured with the mixture using the first or second active material, the change in the thickness of the pressed active material layer is a first changed amount. When the electrode plate is manufactured with the mixture using the third or fourth active material, the change in the thickness of the pressed active material layer is a second changed amount. The first changed amount is smaller than the second changed amount.

As shown in FIG. 9, when the weight per unit area of the mixture is changed based on the tapped density in addition to the specific surface area of the active material used in the mixture, the difference is reduced between the specific surface area of the pressed first active material and the specific surface area of the pressed second active material. In the same manner, when the weight per unit area of the mixture is changed based on the tapped density in addition to the specific surface area of the active material used in the mixture, the difference is reduced between the specific surface area of the pressed third active material and the specific surface area of the pressed fourth active material.

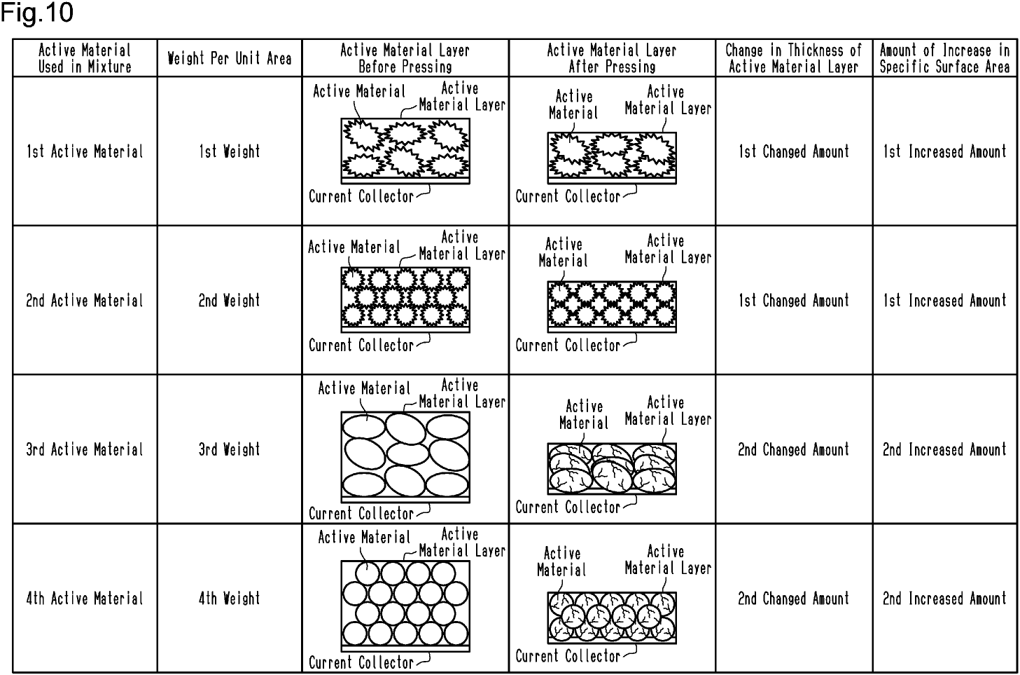

As shown in FIG. 10, in the present example, when the electrode plate is manufactured with the mixture using the first active material, the specific surface area of the active material is increased in the pressing step by a first increased amount. When the electrode plate is manufactured with the mixture using the second active material, the specific surface area of the active material is increased in the pressing step by the first increased amount. When the electrode plate is manufactured with the mixture using the third active material, the specific surface area of the active material is increased in the pressing step by a second increased amount. When the electrode plate is manufactured with the mixture using the fourth active material, the specific surface area of the active material is increased in the pressing step by the second increased amount. The first increased amount is smaller than the second increased amount.

When the third and fourth active materials are pressed, the third and fourth active materials, of which the change in the thickness of the pressed active material layer is relatively large, may crack or be crushed. Accordingly, the specific surface area is increased in the pressing step by a greater amount in the third and fourth active materials than that in the first and second active materials.

When the weight per unit area of the mixture is changed, the amount by which the specific surface area of the active material is increased in the pressing step changes. Thus, even when the physical property of the active material differs between the mixtures, the specific surface area of the pressed active material can be adjusted to a desired specific surface area. In this manner, the weight per unit area of the mixture is changed based on the physical property of the active material used in the mixture so that the specific surface area of the pressed active material, that is, the specific surface area of the active material included in the active material layer, becomes equal to a desired specific surface area. Consequently, this reduces differences in the reactive area between the electrode plates.

The above described embodiment has the following advantages.

(1) The method for manufacturing an electrode plate includes preparing a mixture by kneading an active material. The method includes forming an active material layer on a current collector by applying the mixture to the current collector. The method includes pressing the active material layer so that the active material layer is changed from the first thickness to the second thickness. The mixture applied to the current collector has a weight per unit area based on the specific surface area of the active material used in the mixture and the tapped density of the active material used in the mixture. The active material layer is pressed to a predetermined thickness (uniform thickness).

The performance of the electrode plate is determined by the reactive area of the electrode plate. The reactive area of the electrode plate is determined by the specific surface area of the active material included in the active material layer. The specific surface area of the active material included in the active material layer is increased by pressing the active material layer. As the change in the thickness of the pressed active material layer increases, the specific surface area of the active material included in the active material layer is increased by a greater amount.

When the active material layer is pressed to a predetermined thickness, the change in the thickness of the pressed active material layer is determined by the thickness of the active material layer before the pressing. The thickness of the active material layer before the pressing is affected by the weight per unit area of the mixture applied to the current collector. When the mixture has a greater weight per unit area, the thickness of the active material layer before the pressing step is likely to be relatively large. In other words, when the mixture has a greater weight per unit area, the change in the thickness of the pressed active material layer is likely to become relatively large.

When the tapped density of the active material used in the mixture differs between the mixtures, even if the mixtures have the same weight per unit area, the active material layers may differ in the thickness before the pressing step. Specifically, when the mixtures have the same weight per unit area, a lower tapped density of the active material used in the mixture is likely to result in a relatively large thickness of the active material layer before the pressing step. That is, when the mixtures have the same weight per unit area, a lower tapped density of the active material used in the mixture is likely to result in a relatively large amount of increase in the specific surface area of the pressed active material layer.

The above-described method sets the weight per unit area of the mixture to differ based on the specific surface area and the tapped density, or the physical property of the active material used in the mixture. The weight per unit area of the mixture affects the thickness of the active material layer prior to the pressed step. The thickness of the active material layer prior to the pressing step affects the change in the thickness of the pressed active material layer. The change in the thickness of the pressed active material layer affects the amount of increase in the specific surface area of the pressed active material. In this manner, when the weight per unit area of the mixture is changed based on the physical property of the active material used in the mixture, the amount of increase in the specific surface area of the pressed active material is changed. In other words, the amount by which the specific surface area of the pressed active material is increased can be adjusted by adjusting the weight per unit area of the mixture based on the physical property of the active material used in the mixture. This reduces differences in the reactive area of the electrode plates. Consequently, variations in performance will be reduced between electrode plates.

(2) When the electrode plate is manufactured with the mixture using an active material of which the specific surface area is the first area, the weight per unit area of the mixture is less than that when the electrode plate is manufactured with the mixture using an active material of which the specific surface area is the second area that is smaller than the first area.

With this method, the weight per unit area of the mixture is relatively small when the electrode plate is manufactured with the mixture using an active material of which the specific surface area is relatively large, and the weight per unit area of the mixture is relatively large when the electrode plate is manufactured with the mixture using an active material of which the specific surface area is relatively small. In this manner, when the electrode plate is manufactured with the mixture using the active material of which the specific surface area is the first area, the amount by which the specific surface area of the pressed active material is increased is less than that when the electrode plate is manufactured with the mixture using the active material of which the specific surface area is the second area. In other words, the amount by which the specific surface area is increased in the pressing step is relatively small in the active material of which the initial specific surface area is relatively large, and the amount by which the specific surface area is increased in the pressing step is relatively large in the active material of which the initial specific surface area is relatively small. Consequently, this reduces difference in the reactive area of the electrode plates.

(3) When the electrode plate is manufactured with the mixture using an active material of which the specific surface area is the first area and the tapped density is the first density, the weight per unit area of the mixture is less than that when the electrode plate is manufactured with the mixture using an active material of which the specific surface area is the first area and the tapped density is the second density that is greater than the first density.

Even when the active materials used in the mixtures have the same specific surface area, if the tapped density differs between the active materials, the amount of increase in the specific surface area of the pressed active material may differ one from another. A lower tapped density of the active material used in the mixture is likely to result in a relatively large thickness of the active material layer prior to the pressing step. In other words, a lower tapped density of the active material used in the mixture is likely to result in a relatively large change in the thickness of the pressed active material layer. Therefore, a lower tapped density of the active material used in the mixture is likely to result in a relatively large amount of increase in the specific surface area of the pressed active material layer.

With this method, the weight per unit area of the mixture is relatively large when the electrode plate is manufactured with the mixture using an active material of which the tapped density is relatively large, and the weight per unit area of the mixture is relatively small when the electrode plate is manufactured with the mixture using an active material of which the tapped density is relatively small. This reduces difference in the first thickness between when the electrode plate is manufactured with the mixture using an active material of which the tapped density is the first density and when the electrode plate is manufactured with the mixture using an active material of which the tapped density is the second density. Accordingly, this reduces differences in the amount by which the specific surface area of the active material is increased in the pressing step between when the electrode plate is manufactured with the mixture using an active material of which the tapped density is the first density and when the electrode plate is manufactured with the mixture using an active material of which the tapped density is the second density. Consequently, this reduces difference in the reactive area of the electrode plates.

(4) When the electrode plate is manufactured with the mixture using an active material of which the specific surface area is the second area and the tapped density is the first density, the weight per unit area of the mixture is less than that when the electrode plate is manufactured with the mixture using an active material of which the specific surface area is the second area and the tapped density is the second density that is greater than the first density.

Even when the active materials used in the mixtures have the same specific surface area, if the tapped density differs between the active materials, the amount of increase in the specific surface area of the pressed active material may differ one from another. A lower tapped density of the active material used in the mixture is likely to result in a relatively large thickness of the active material layer prior to the pressing step. In other words, a lower tapped density of the active material used in the mixture is likely to result in a relatively large change in the thickness of the pressed active material layer. Therefore, a lower tapped density of the active material used in the mixture is likely to result in a relatively large amount of increase in the specific surface area of the pressed active material layer.

With this method, the weight per unit area of the mixture is relatively large when the electrode plate is manufactured with the mixture using an active material of which the tapped density is relatively large, and the weight per unit area of the mixture is relatively small when the electrode plate is manufactured with the mixture using an active material of which the tapped density is relatively small. This reduces difference in the first thickness between when the electrode plate is manufactured with the mixture using an active material of which the tapped density is the first density and when the electrode plate is manufactured with the mixture using an active material of which the tapped density is the second density. Accordingly, this reduces the difference in the amount of increase in the specific surface area of the pressed active material between when the electrode plate is manufactured with the mixture using an active material of which the tapped density is the first density and when the electrode plate is manufactured with the mixture using an active material of which the tapped density is the second density. Consequently, this reduces the difference in the reactive area of the electrode plates.

The above-above-described embodiment may be changed as follows. The above embodiment and the following modifications can be combined as long as the combined modifications remain technically consistent with each other.

The electrode body 15 is not limited to having a structure in which the positive plate 16, the negative plate 17, the separator 18, and the separator 19 are stacked and rolled together. For example, the electrode body 15 may have a structure in which the positive plate 16, the negative plate 17, the separator 18, and the separator 19 are stacked one upon another without being rolled together.

In the example, the weight per unit area of the mixture is changed in four stages based on the physical property of the active material. However, there is no limitation to such a configuration. The weight per unit area of the mixture may be changed in two or three stages based on the physical property of the active material. The number of stages may be five or greater.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A method for manufacturing an electrode plate including a current collector and an active material layer, the method comprising:
preparing a mixture by kneading an active material;
forming the active material layer on the current collector by applying the mixture to the current collector; and
pressing the active material layer so that active material layer has a predetermined thickness,
wherein the mixture applied to the current collector has a weight per unit area based on a specific surface area of the active material used in the mixture and a tapped density of the active material used in the mixture.

2. The method according to claim 1, wherein, when the electrode plate is manufactured with the mixture using the active material of which the specific surface area is a first area, the weight per unit area of the mixture is less than that when the electrode plate is manufactured with a mixture using the active material where the specific surface area is a second area that is smaller than the first area.

3. The method according to claim 2, wherein, when the electrode plate is manufactured with the mixture using the active material of which the specific surface area is the first area and the tapped density is a first density, the weight per unit area of the mixture is less than that when the electrode plate is manufactured with a mixture using the active material where the specific surface area is the first area and the tapped density is a second density that is greater than the first density.

4. The method according to claim 2, wherein, when the electrode plate is manufactured with the mixture using the active material of which the specific surface area is the second area and the tapped density is a first density, the weight per unit area of the mixture is less than that when the electrode plate is manufactured with a mixture using the active material where the specific surface area is the second area and the tapped density is a second density that is greater than the first density.

5. A method for manufacturing a battery including an electrode plate that includes a current collector and an active material layer, the method comprising:
preparing a mixture by kneading an active material;
forming the active material layer on the current collector by applying the mixture to the current collector; and
pressing the active material layer so that active material layer has a predetermined thickness,
wherein the mixture applied to the current collector has a weight per unit area based on a specific surface area of the active material used in the mixture and a tapped density of the active material used in the mixture.
